(19) United States
(12) Patent Application Publication
(10) Pub. No.: US 2026/0166951 A1
(43) Pub. Date: Jun. 18, 2026

(54) AIR CONDITIONING CONTROL SYSTEM AND METHOD, AND A VEHICLE INCLUDING THE SAME

(71) Applicants: HYUNDAI MOTOR COMPANY, Seoul (KR); KIA CORPORATION, Seoul (KR)

(72) Inventors: Nam Seok Yun, Hwaseong-si (KR); Bo Hyeon Ryu, Hwaseong-si (KR)

(73) Assignees: HYUNDAI MOTOR COMPANY, Seoul (KR); KIA CORPORATION, Seoul (KR)

(21) Appl. No.: 19/383,171

(22) Filed: Nov. 7, 2025

(30) Foreign Application Priority Data
Dec. 13, 2024 (KR) 10-2024-0185710

(51) Int. Cl. B60H 1/00

(52) U.S. Cl. CPC B60H 1/0073

(57) ABSTRACT

An air conditioning control system includes: an edge device that predicts a vehicle speed of a vehicle traveling from a garage to a destination based on a vehicle speed prediction model and calculate a system duty of an air conditioner compressor based on the predicted vehicle speed; and an air control panel that controls the system duty of the air conditioner compressor based on the system duty calculated by the edge device.

### CROSS-REFERENCE TO RELATED APPLICATION

This application claims priority to and the benefit of Korean Patent Application No. 10-2024-0185710, filed on Dec. 13, 2024, the disclosure of which is incorporated herein by reference in its entirety.

### FIELD

The present disclosure generally relates to an air conditioning control system, a control method thereof, and a vehicle.

### BACKGROUND

A roof-type air conditioning system installed in a vehicle is designed to efficiently cool a large space, to maintain a comfortable temperature inside the vehicle, and to provide a wider interior space. The operation of the roof-type air conditioning system is described as follows. When a refrigerant is compressed by a compressor, a condenser converts the compressed refrigerant into a refrigerant in a liquid state, and the refrigerant in a liquid state cools internal air while evaporating. An inverter regulates the operating intensity of the compressor to control cooling.

Air conditioner performance is classified by a coefficient of performance (COP), which stands for an air conditioner performance coefficient or a cooling performance coefficient. The COP is an indicator of the energy efficiency of an air conditioning system and is a value obtained by measuring how much cooling effect (cooling amount) the system provides relative to energy consumed by the system.

Conventionally, an air conditioning system is operated at 100% full duty to quickly cool an interior to a low temperature under high load exterior conditions (e.g., high temperature and humidity). However, when the duty is maintained at 100% while the vehicle travels, the rotation of the compressor is also at its maximum, and the COP fluctuates greatly depending on a vehicle speed of the vehicle. As a result, wasted energy increases. Therefore, there is a need for a technology that can maintain cooling performance while maintaining a high COP.

The above information disclosed in this Background section is only for understanding of the background of the disclosure, and, therefore, it may contain information that does not constitute prior art.

### SUMMARY

In order to solve the above-described problems, the present disclosure provides an air conditioning control system, a control method thereof, and a vehicle, which are capable of reducing air conditioning operation energy that may be wasted while operating an air conditioning system during bus driving and ensuring rapid cooling performance even with a high air conditioner performance coefficient.

The objects of the present disclosure are not limited to the object described above, and other objects not described will be clearly understood by those having ordinary skill in the technical field to which the present disclosure belongs from the description below.

According to an embodiment of the present disclosure, an air conditioning control system includes: an edge device that predicts a vehicle speed of a vehicle traveling from a starting location (e.g., a garage) to a destination based on a vehicle speed prediction model and calculates a system duty of an air conditioner compressor based on a predicted vehicle speed; and an air control panel that controls the system duty of the air conditioner compressor based on the system duty calculated by the edge device.

The edge device may generate the vehicle speed prediction model that predicts the vehicle speed of the vehicle based on past traveling data collected from the vehicle traveled in a past and generate a system duty model that calculates the system duty based on the vehicle speed predicted by the vehicle speed prediction model.

The edge device may generate the system duty model further based on a difference between a set interior temperature and a current interior temperature of the vehicle.

The edge device may calculate the system duty using the system duty model such that a coefficient of performance becomes higher than a reference value based on the predicted vehicle speed.

The system duty model may be as follows:

$$D = {k}_{1} \cdot Δ t + {k}_{2} \cdot ( 1 - \frac{v ( t )}{{v}_{max}} )$$

Here, D is a system duty of the air conditioner compressor, Δt is a difference between tᵣₒₒₘ and tₛₑₜ, tᵣₒₒₘ is a current interior temperature of the vehicle, tₛₑₜ is a set temperature, v(t) is a predicted vehicle speed, vₘₐₓ is a maximum speed of the vehicle, and k₁ and k₂ are system duty adjustment coefficients.

The air control panel may control the system duty in real time based on a measured actual vehicle speed of the vehicle when a discrepancy occurs between the vehicle speed predicted by the vehicle speed prediction model and the actual vehicle speed.

The edge device may modify the vehicle speed prediction model based on traveling data collected during a set period when the discrepancy occurs N or more times (N is an integer greater than or equal to 2) during the set period.

Meanwhile, a control method of an air conditioning control system according to another embodiment of the present disclosure includes: predicting, by an edge device, a vehicle speed of a vehicle traveling from a starting location (e.g., a garage) to a destination based on a vehicle speed prediction model and calculating a system duty of an air conditioner compressor based on a predicted vehicle speed; and controlling, by an air control panel, the system duty of the air conditioner compressor based on the system duty calculated by the edge device.

The control method of an air conditioning control system may further include: generating, by the edge device, the vehicle speed prediction model that predicts the vehicle speed of the vehicle based on past traveling data collected from the vehicle traveled in a past; and generating, by the edge device, a system duty model that calculates the system duty based on the vehicle speed predicted by the vehicle speed prediction model.

The calculating of the system duty may include calculating the system duty using the system duty model such that a coefficient of performance becomes higher than a reference value based on the predicted vehicle speed.

The control method of an air conditioning control system may further include controlling, by the air control panel, the system duty in real time based on a measured actual vehicle speed of the vehicle when a discrepancy occurs between the vehicle speed predicted by the vehicle speed prediction model and the actual vehicle speed.

The control method of an air conditioning control system may further include modifying, by the edge device, the vehicle speed prediction model based on traveling data collected during a set period when the discrepancy occurs N or more times (N is an integer greater than or equal to 2) during the set period.

Meanwhile, a vehicle equipped with a roof-type air conditioning system according to another embodiment of the present disclosure includes: an edge device that predicts a vehicle speed of the vehicle traveling from a starting location (e.g., a garage) to a destination based on a vehicle speed prediction model and calculates a system duty of an air conditioner compressor based on a predicted vehicle speed; and an air control panel that controls the system duty of the air conditioner compressor based on the system duty calculated by the edge device.

It is to be understood that both the foregoing general description and the following detailed description are exemplary and explanatory and are intended to provide further explanation of the disclosure as claimed.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a schematic view showing a vehicle equipped with an air conditioning system according to an embodiment of the present disclosure;

FIG. 2 is a schematic diagram showing a change in a coefficient of performance (COP) according to a vehicle speed of the vehicle;

FIG. 3 is a schematic block diagram schematically illustrating the vehicle according to the embodiment of the present disclosure;

FIG. 4 is a schematic conceptual diagram showing the overall operation of an air conditioning control system;

FIG. 5 is a schematic block diagram showing an edge device;

FIG. 6 is a schematic example diagram for describing an operation of controlling a system duty based on model-based predictive control (MPC) by a vehicle or air conditioning control system according to the embodiment of the present disclosure;

FIG. 7 is a schematic example diagram for comparing and describing COPs when controlling the system duty based on a vehicle speed prediction model according to the embodiment of the present disclosure and when controlling the system duty using the conventional method;

FIG. 8 is a schematic example diagram for describing an operation of generating and updating the vehicle speed prediction model by a first processor;

FIG. 9 is a schematic flowchart showing a control method of the air conditioning control system according to the embodiment of the present disclosure; and

FIG. 10 is a schematic flowchart showing a method of generating and updating the vehicle speed prediction model of the edge device according to the embodiment of the present disclosure.

### DETAILED DESCRIPTION

The above objects, other objects, features and advantages of the present disclosure will be readily understood through the following embodiments related to the attached drawings. However, the present disclosure is not limited to the embodiments which will be described herein and may be embodied in other forms. Rather, the embodiments to be introduced herein are provided to ensure that the disclosure is thorough and complete and to sufficiently convey the spirit of the present disclosure to those skilled in the art.

In some cases, it is described in advance that portions which are commonly known but not closely related to the disclosure are not described in order to avoid unnecessary confusion in describing the present disclosure.

When terms such as first, second, etc., are used in this disclosure to describe components, these components should not be limited by such terms. These terms are simply used to distinguish one component from another component.

Additionally, when it is described that a first component operates or executes on a second component, it should be understood that the first component operates or executes in an environment in which the second component operates or executes or operates or executes through direct or indirect interaction with the second component.

When it is described that a component, device, or system includes a component consisting of a program or software, even when there is no explicit mention, it should be understood that the component, device, or system includes hardware (e.g., a memory, a central processing unit (CPU), etc.) necessary for the program or software to execute or operate or other programs or software (e.g., an operating system, drivers necessary to operate hardware, etc.).

Additionally, unless otherwise specifically described in implementing a component, it should be understood that the component may be implemented in the form of software, hardware, or both software and hardware.

In addition, the terms used in this disclosure are for describing the embodiments and are not intended to limit the present disclosure. In this disclosure, a singular form includes a plural form unless specifically described otherwise in the text. The words “comprise” and/or “comprising” as used in this disclosure means that the described component does not exclude the presence or addition of one or more other components.

Additionally, terms such as “unit,” “module,” “server,” “system,” “device,” and “terminal” in this disclosure may be intended to refer to a functional and structural combination of hardware and software driven by or for driving the hardware. For example, the hardware here may be a data processing device including a CPU or another processor. Additionally, software driven by hardware may refer to an executing process, object, executable, thread of execution, program, etc. When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

In addition, it may be easily inferred by an average expert in the technical field of the present disclosure that the above terms may mean a logical unit of a given code and hardware resources for executing the given code and do not necessarily mean physically connected code or a type of hardware.

Additionally, in this disclosure, a data base (DB) may mean a functional and structural combination of software and hardware for storing information corresponding to each DB. The DB may be implemented with at least one table and may further include a separate data base management system (DBMS) for searching, storing, and managing information stored in the DB. In addition, the DB may be implemented in various ways, such as in the forms of a linked-list DB, a tree DB, a relational DB, etc., and includes all data storage media and data structures capable of storing information corresponding to the DB.

It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Hereinafter, the specific technical contents to be implemented in the present disclosure are described in detail with reference to the attached drawings.

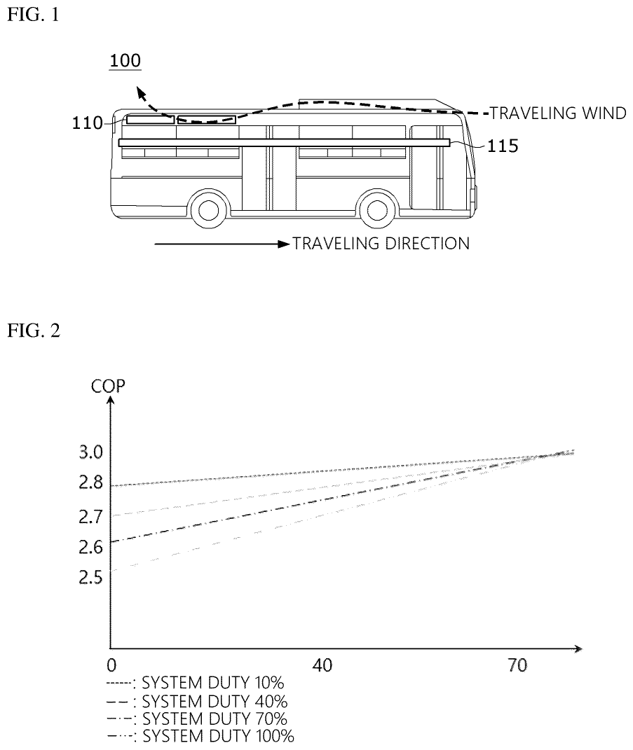

FIG. 1 is a schematic view showing a vehicle 100 equipped with an air conditioning system 110 according to an embodiment of the present disclosure.

Referring to FIG. 1, the vehicle 100 according to the embodiment of the present disclosure may include the air conditioning system 110 and an air conditioner duct 115.

The vehicle 100 equipped with the air conditioning system 110 may be not only a bus as shown but also a large sport utility vehicle (SUV), a medium-sized vehicle, or a compact vehicle. However, it is not limited thereto. For example, the air conditioning system may be a roof-type air conditioning unit equipped on a roof.

The air conditioning system 110 may be mounted on the roof of the vehicle 100 and may reduce the temperature inside the vehicle. The air conditioning system 110 may include a compressor, a condenser, an evaporator, and an inverter etc.

A refrigerant becomes high-temperature and high-pressure gas in the compressor, and the high-temperature and high-pressure refrigerant discharges heat in the condenser and becomes a refrigerant in a liquid state. The high-temperature and high-pressure refrigerant may exchange heat with external air in the condenser. The refrigerant in a liquid state absorbs heat while evaporating in the evaporator and cools ambient air. The inverter regulates cooling by controlling a system duty, i.e., a rotational speed of the compressor.

The air conditioner duct 115 may provide a passage for delivering the cooled air into an interior. The air conditioner duct 115 may control air flow and distributes the air flow appropriately to maintain an even interior temperature.

When the air conditioning system 110 is mounted on the roof of the vehicle 100, as a vehicle speed increases, a traveling wind (air amount) flowing into the condenser may increase, which increases a heat dissipation amount (i.e., cooling performance) of the condenser, lowers a refrigerant pressure, and accordingly, reduces the load on the compressor. Therefore, the power consumption required to maintain the rotation of the compressor may be reduced, thereby increasing a coefficient of performance (COP) of an air conditioner. The COP is as follows:

$$COP = \frac{Qc}{W}$$

Qc is the air conditioner cooling capacity or cooling performance, and the unit thereof is kW. W is the air conditioner power consumption or air conditioner input, and the unit thereof is W. According to the equation, the higher the COP value, the more efficiently the air conditioning system 110 performs cooling work.

FIG. 2 is a schematic diagram showing a change in COP according to the vehicle speed of the vehicle 100. In other words, FIG. 2 may illustrate the change in COP of the air conditioner according to system duty and vehicle speed.

Referring to FIG. 2, a system duty of 100% may mean that the compressor rotates at a maximum RPM. For example, in a case where the compressor is driven at 100% system duty, when the vehicle speed is 0, the COP may be approximately 2.5, and when the vehicle speed is 70, the COP may be approximately 3. For example, in a case where the compressor is driven at 10% system duty, when the vehicle speed is 0, the COP may be approximately 2.8, and when the vehicle speed is 70, the COP may be approximately 3. That is, when the system duty is small, a difference in the COP between a stationary state and a traveling state may not be large compared to when the system duty is large.

When the system duty is 100%, the compressor may rotate the fastest, and thus a pressure of the compressor may significantly increase, and when the vehicle is stopped in a state where the pressure of the compressor significantly increases, there may be no traveling wind, and thus the cooling performance may decrease. On the other hand, when the system duty is 10%, the compressor may rotate less and may be driven at a low pressure, and thus even when the traveling wind increases due to traveling, the degree to which the COP increases may be relatively low.

The embodiment of the present disclosure may secure optimal efficiency and improve power consumption by utilizing the COP obtained through an actual vehicle evaluation, that is, the COP that changes according to the vehicle speed and the system duty, for air conditioning system control.

In addition, the present disclosure does not simply control the air conditioning system by feeding back the system duty in real time according to an actual vehicle speed. The present disclosure may predict a near-future vehicle speed through artificial intelligence (AI) machine learning using big data that are acquired through driving and controls the system duty according to the predicted vehicle speed, thereby increasing the efficiency of the air conditioning system 110 while also securing rapid effectiveness. However, there may be cases where cooling is performed at 100% duty even at low speeds and with a low COP depending on the situation.

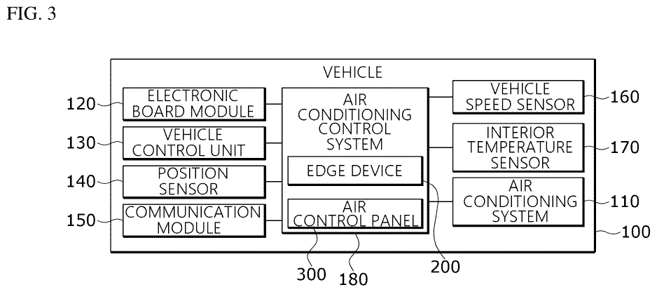

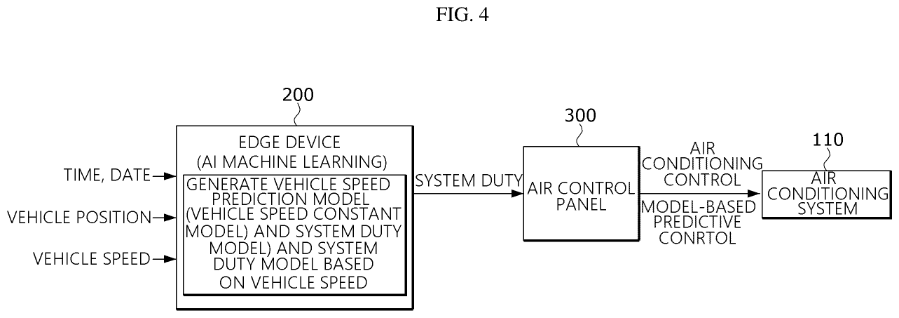

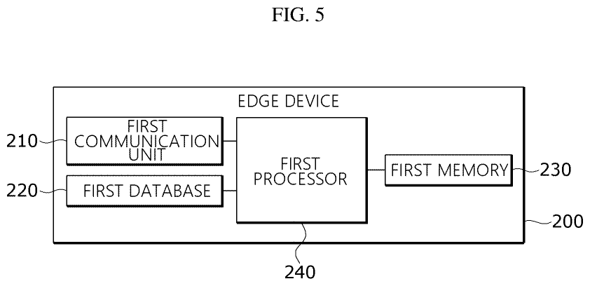

FIG. 3 is a schematic block diagram schematically illustrating the vehicle 100 according to the embodiment of the present disclosure, and FIG. 4 is a conceptual diagram showing the overall operation of an air conditioning control system 180.

Referring to FIG. 3, according to the embodiment of the present disclosure, the vehicle 100 may include the air conditioning system 110, an electronic board module 120, a vehicle control unit (VCU) 130, a position sensor 140, a communication module 150, a vehicle speed sensor 160, an interior temperature sensor 170, and the air conditioning control system 180.

When the vehicle 100 is a bus, the electronic board module 120 may include a display device for displaying a route number entered by a driver, and a communication circuit for transmitting the displayed route number to an external device (e.g., an edge device 200).

The VCU 130 may control and manage the main electronic systems of the vehicle 100. When the vehicle 100 is an electric bus, the VCU 130 may control the operation of a powertrain including a motor, a battery, a charging system, etc., and control the vehicle 100 such that driving performance, energy efficiency, and safety are optimized.

Additionally, the VCU 130 may transmit a timestamp including at least one of the date, day of the week, and time of operating the vehicle 100 to the edge device 200 through a controller area network (CAN) signal. The timestamp may be transmitted periodically while the vehicle travels from a garage (or a starting point) to a destination. Alternatively, the timestamp may be received from an external server (not shown) through an open application programming interface (API). The external server (not shown) may be, for example, a server that manages the operation of the vehicle 100.

The VCU 130 and an air control panel (ACP) 300 may be provided in the form of an embedded system inside the vehicle 100 and may be electrically connected to communicate with each other. Additionally, at least one of the VCU 130 and the ACP 300 may be implemented in various forms such as an electronic control unit (ECU), a micro controller unit (MCU), a CPU, and a microprocessor.

The position sensor 140 may detect a current position of the vehicle 100 while the vehicle 100 travels and may transmit the detected position to the edge device 200. The position sensor 140 may be a global positioning system (GPS) module. However, it is not limited thereto. For example, the position sensor 140 may be global navigation satellite system (GLONSS) or Galileo etc.

The communication module 150 may include one or more components that enable communication between components within the vehicle 100 or between the vehicle 100 and an external device (not shown) and may include, for example, at least one of a short-range communication module, a wired communication module, and a wireless communication module.

For example, the communication module 150 may include at least one of various modules such as a cellular communication module of an LTE modem or a 5G modem, a Wi-Fi module, a Bluetooth module, a Vehicle-to-Everything (V2X) communication module, a controller area network (CAN) gateway, and an Ethernet communication module. The external device (not shown) includes a driver mobile terminal, an external server, an intelligent transportation system (ITS), etc.

The communication module 150 may receive bus arrival information, i.e., expected arrival time at a stop, from the external device (not shown) through the open API.

The vehicle speed sensor 160 may detect the vehicle speed in real time or periodically while the vehicle 100 travels from a garage (or a starting point) to a destination. The detected vehicle speed (hereinafter referred to as an “actual vehicle speed”) may be transmitted to the edge device 200 via the communication module 150 or directly from the vehicle speed sensor 160 to the edge device 200, and a CAN signal may be used.

The interior temperature sensor 170 may detect the interior temperature of the vehicle 100 and transmit the detected temperature to the edge device 200.

The air conditioning system 110 may be a unit provided in the vehicle 100 and may be a roof-type air conditioning unit described with reference to FIG. 1.

The air conditioning control system 180 may include the edge device 200 and the air control panel (ACP) 300. The edge device 200 may generate a vehicle speed prediction model that predicts a near-future vehicle speed of the vehicle 100 based on past traveling data collected while the vehicle 100 was driven (or travelled) in the past.

Additionally, the edge device 200 may generate a system duty model that calculates the system duty based on the vehicle speed predicted by the vehicle speed prediction model. The edge device 200 may generate the system duty model further based on a difference between a set interior temperature and a current interior temperature of the vehicle 100.

In addition, the edge device 200 may predict the vehicle speed of the vehicle 100 based on the vehicle speed prediction model while the vehicle 100 travels and may calculate (or predict) the system duty of the air conditioner compressor based on the predicted vehicle speed.

For example, the edge device 200 may adjust the system duty using the system duty model by predicting a section in which the COP becomes higher than a reference value based on the predicted vehicle speed. That is, the system duty model may calculate (or predict) the system duty that allows the COP of the air conditioning system 110 which is changed by the control of the system duty to be maintained at a value greater than a preset reference value. The reference value is an average value of an operable COP in the air conditioning system 110. For example, when the operable COP is in the range of about 2.5 to about 3.0, the reference value may be about 2.75.

The ACP 300 may control the system duty of the compressor based on the system duty calculated by the system duty model, and the compressor may be driven while changing the rotation speed according to the system duty.

FIG. 5 is a schematic block diagram showing the edge device 200.

The edge device 200 may be an on-device that is installed in the vehicle 100 to collect and process data. The edge device 200 may predict the vehicle speed of the vehicle 100 traveling from a garage (or a starting point) to a destination based on the vehicle speed prediction model and calculate the system duty of the air conditioner compressor based on the predicted vehicle speed.

Referring to FIG. 5, the edge device 200 may include a first communication unit 210, a first data base (DB) 220, a first memory 230, and a first processor 240.

The first communication unit 210 may communicate with the electronic board module 120, the VCU 130, the position sensor 140, the communication module 150, the vehicle speed sensor 160, the interior temperature sensor 170, and the ACP 300 through wired or wireless communication. The first communication unit 210 may include at least one of various modules such as a cellular communication module, a Wi-Fi module, a Bluetooth module, a Vehicle-to-Everything (V2X) communication module, a controller area network (CAN) gateway, and an Ethernet communication module.

The first DB 220 may store the route number of the vehicle 100 which is received from the electronic board module 120, the timestamp and vehicle speed received from the VCU 130, the position of the vehicle 100 received from the position sensor 140, the bus arrival information received through the communication module 150 and the open API, the current vehicle speed received from the vehicle speed sensor 160, and the current interior temperature received from the interior temperature sensor 170 as the traveling data of the vehicle 100.

The first memory 230 may store at least one program (e.g., an operating system, software, firmware, middleware, or an application, etc.), various types of data, and at least one command for controlling the edge device 200 and load the program, read or write data, or perform an operation corresponding to the command at the request of the first processor 240. The first memory 230 may include a volatile memory and a non-volatile memory. The first memory 230 may store a program for generating a vehicle speed prediction model and a system duty model and the generated vehicle speed prediction model and system duty model.

The first processor 240 may perform overall control of the edge device 200 according to an input command. The command may be input to the first processor 240 by the first memory 230 or the first communication unit 210. For example, the first processor 240 may perform data processing and operations by executing the program or command stored in the first memory 230.

Additionally, the first processor 240 may load a command or data received from another component into the volatile memory, process the command or data stored in the volatile memory, and store the processing result in the non-volatile memory.

In the embodiment of the present disclosure, the first processor 240 may generate the vehicle speed prediction model that learns the traveling data collected while the vehicle 100 travels for a certain period and predicts the near-future vehicle speed and may generate the system duty model that calculates the system duty based on the vehicle speed predicted by the vehicle speed prediction model.

Additionally, the first memory 240 may predict the near-future vehicle speed using the generated vehicle speed prediction model and calculate the system duty based on the predicted vehicle speed.

The operation of generating the vehicle speed prediction model and the system duty model will be described below.

The first processor 240 may process the traveling data collected while the vehicle 100 travels and store the traveling data in the first DB 220. Table 1 may show the types, acquisition methods, and utilization methods of traveling data stored in the first DB 220.

TABLE 1

| Traveling data | Acquisition method | Processing method | Utilization method |
|---|---|---|---|
| Route number | Vehicle electronic | Route number | Generation of vehicle |
| | board signal | | speed model according to |
| | | | route |
| Timestamp | CAN signal or | Record of traveling | Time and date reference |
| (time and date) | Open AI in vehicle | time and date | with respect to heat |
| | | | amount change acquired |
| | | | during traveling |
| Vehicle position | GPS in vehicle | Record of GPS | Vehicle position reference |
| | | position | with respect to heat |
| | | | amount change acquired |
| | | | during traveling |
| Bus arrival | Open AI | Expected arrival time | Determination of |
| information | | at stop | prediction control on/off |
| | | | time (operation time |
| | | | adjustment or the like on |
| | | | congestion) |
| Vehicle speed | CAN signal in | Vehicle speed heat | COP increases as vehicle |
| | vehicle | dissipation amount, | speed increase |
| | | COP increase or | |
| | | decrease | |

Referring to Table 1, the traveling data may include the route number, timestamp (time and date), vehicle position, bus arrival information, and vehicle speed of the vehicle 100. The acquisition method may be a method of acquiring the traveling data, a processing method is a method of processing the traveling data to determine what kind of signal the traveling data is, and the utilization method shows how the traveling data is utilized. When traveling data is collected for a certain period and big data is secured, the first processor 240 may input the collected traveling data or vehicle speed data into an artificial intelligence model and may cause the artificial intelligence model to perform machine learning, and as a result, a vehicle speed prediction model that predicts the near-future vehicle speed while the vehicle 100 actually travels may be generated.

Additionally, the first processor 240 may generate a system duty model that predicts and controls the system duty of the compressor of the traveling vehicle 100 based on the vehicle speed predicted by the vehicle speed prediction model. Additionally, the first processor 240 may generate a system duty model which calculates or predicts a system duty that allows the COP which is changed by the system duty to be maintained at a value greater than a preset reference value.

Therefore, when applied to the actual vehicle 100, the system duty model may calculate or predict a system duty that allows the COP of the air conditioning system 110 which is changed by the control of the system duty to be maintained at a value greater than a preset reference value.

Equation 1 may represent the generated system duty model.

$$D = {k}_{1} \cdot Δ t + {k}_{2} \cdot ( 1 - \frac{v ( t )}{{v}_{max}} ) \qquad Equation 1$$

Referring to Equation 1, the system duty model is a function model, here, D is a system duty of the air conditioner compressor, Δt is a difference between tᵣₒₒₘ and tₛₑₜ, tᵣₒₒₘ is a current interior temperature of the vehicle 100, tₛₑₜ is a set temperature desired by the user, v(t) is a near-future vehicle speed predicted by the vehicle speed prediction model, vₘₐₓ is a maximum speed set for the vehicle 100, and k₁ and k₂ are system duty adjustment coefficients.

A range of the near future may be specified by the user or model manager and include, for example, the time when the vehicle is in a standby state in the garage, the time when the vehicle will arrive at the next stop during the traveling, and the time when the maximum speed is predicted between stops.

According to the system duty model of Equation 1, as Δt increases, D increases, and thus the output of the air conditioning system 110 may increase.

In addition, as v(t) increases,

$$( 1 - \frac{v ( t )}{{v}_{max}} )$$

decreases relatively, and thus D is more affected by Δt.

Additionally, the influence of Δt and a vehicle speed change on the system duty may be adjusted through k₁ and k₂, and k₁ and k₂ may be adjusted through the real vehicle evaluation data in FIG. 2.

In addition, the system duty model based on the predicted vehicle speed may include the position of the vehicle 100 detected via the GPS and location information of the stop and include information on which stop the vehicle mainly arrives at and departs from, at what time and minute, for each route time slot every day by utilizing the bus arrival information of the open API.

Additionally, a first vehicle and a second vehicle that travel on the same route may share the system duty model based on the predicted vehicle speed with each other. For example, when the route number of the first vehicle changes from 100 to 200 and the route number of the second vehicle is 200, the edge device of the first vehicle may receive the vehicle speed prediction model and the system duty model from the edge device of the second vehicle and control the duty based on the vehicle speed prediction. At this time, the first vehicle and the second vehicle may transmit and receive data through a modem equipped in each vehicle.

The first processor 240 may store the generated vehicle speed prediction model and system duty model in the first memory 230. Thereafter, while the vehicle 100 travels on the route, the first processor 240 may predict the near-future vehicle speed using the vehicle speed prediction model and input the predicted vehicle speed into the system duty model to calculate the system duty for controlling the compressor. That is, the first processor 240 may predict or calculate the system duty by executing model-based predictive control (MPC) using Equation 1 while the vehicle 100 travels on the route. As a result, it is possible to reduce air conditioning operation energy that may be wasted when the vehicle 100 travels and provide an effect of improving the energy efficiency of public transportation.

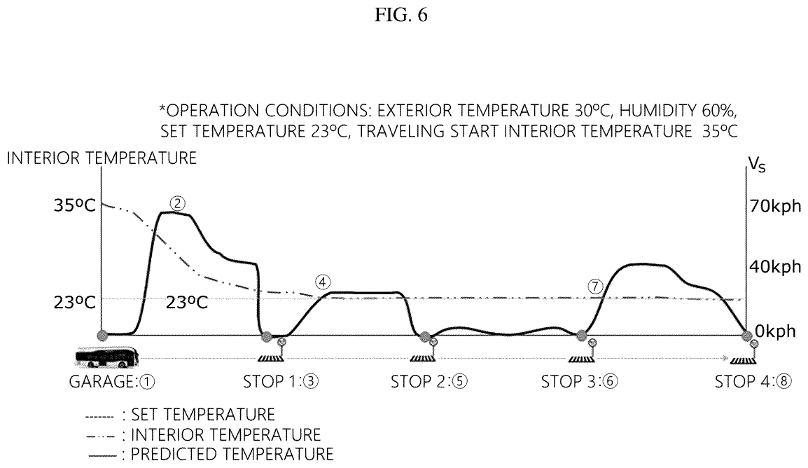

FIG. 6 is a schematic example diagram for describing an operation of controlling a system duty based on the MPC by the vehicle 100 or air conditioning control system 180 according to the embodiment of the present disclosure.

Referring to FIGS. 2 and 6, the vehicle 100 is stopped in the standby state in the garage, the current interior temperature is 35° C., and the set desired temperature is 23° C. In the case of section \textcircled{1}, the difference between the interior temperature and the set temperature is greater than a first criterion (e.g., 10° C.), and thus it is necessary to operate the air conditioning system at 100% system duty. However, the vehicle speed may be predicted to enter a COP increasing point from a 100% system duty section, and thus the first processor 240 may calculate 70% system duty which is one step lower than 100% system duty. Accordingly, the ACP 300 may control the compressor such that the compressor operates at 70% system duty, and thus the air conditioning system 110 may operate with a COP of about 2.6 to cool down.

When the difference between the interior temperature and the set temperature is less than a second criterion (e.g., 3° C.), the first processor 240 may calculate 10% system duty which is the lowest section. Accordingly, the ACP 300 may control the compressor such that the compressor operates at 10% system duty, and thus the COP of the air conditioning system 110 may be about 2.8 as shown in FIG. 2 in the stationary state.

In the case of section \textcircled{2}, the vehicle speed of the vehicle 100 increases as predicted, and thus the first processor 240 may calculate 100% system duty, and the ACP 300 may control the compressor such that the compressor operates at 100% system duty. Therefore, the interior temperature of the vehicle 100 may be rapidly lowered, the COP may increase, and the system efficiency may increase.

In the case of section \textcircled{3}, the vehicle 100 is stopped at stop 1 for a certain period of time. Since the difference between the current interior temperature of the vehicle 100 and the set temperature is smaller than the second criterion (e.g., 3° C.) or a third criterion (e.g., 2° C.), and the near-future vehicle speed is predicted to increase, a high-duty operation may be unnecessary while the vehicle is stopped at stop 1. Accordingly, the first processor 240 may calculate the lowest 10% system duty, and the ACP 300 may perform air conditioning control to secure the maximum COP with 10% system duty.

In the case of section \textcircled{4}, the vehicle speed of the vehicle 100 increases, and thus the first processor 240 may increase the system duty compared to when the vehicle is stopped at stop 1 such that the difference between the set temperature and the interior temperature approaches 0.

In the case of section \textcircled{5}, the vehicle 100 is stopped at stop 2 for a certain period of time and then starts traveling again. The near-future vehicle speed may be predicted to slightly increase although the vehicle speed is smaller than the predicted speed in section (3), and the difference between the current interior temperature and the set temperature may approach 0, and thus the first processor 240 may calculate 10% system duty while the vehicle is stopped at stop 2.

In the case of section \textcircled{6}, the vehicle 100 is stopped at stop 3 for a certain period of time and then starts traveling again. The near-future vehicle speed may be predicted to increase, and the difference between the current interior temperature and the set temperature may approach 0, and thus the first processor 240 may calculate 10% system duty.

In the case of section \textcircled{7}, the interior temperature approaches the set temperature, and thus the first processor 240 may calculate 10% system duty to maintain cooling with a high COP at the lowest system duty.

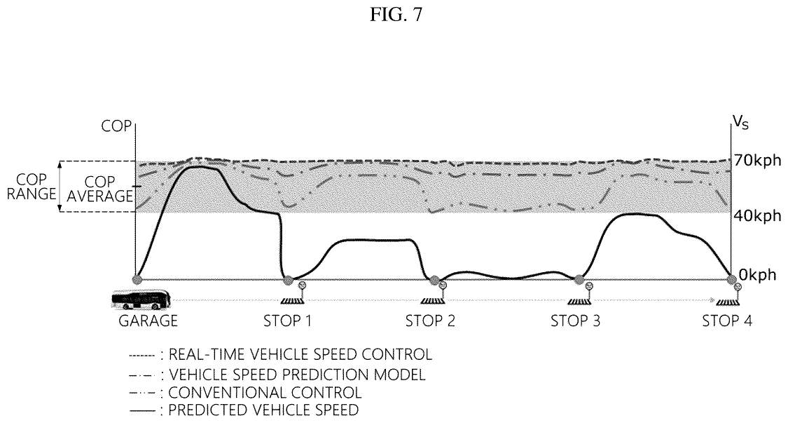

FIG. 7 is a schematic example diagram for comparing and describing COPs when controlling the system duty based on the vehicle speed prediction model according to the embodiment of the present disclosure and when controlling the system duty using the conventional method.

Referring to FIGS. 2 and 7, the COP range is a range from the minimum value to the maximum value of the COP that is implemented in the air conditioning system 110, and the COP average is an average of the COP range. Vs is the vehicle speed of the vehicle 100.

In the case of the conventional control method, when the set temperature of the vehicle is set, the COP may be low in the garage because the vehicle is stopped in the garage. When the vehicle starts traveling and travels at, for example, 100% system duty, the COP at a vehicle speed of 0 may be 2.5, and the COP at a vehicle speed of 70 may approach 3. That is, the conventional control may have a pattern that the COP is low when the vehicle is stopped, increases while the vehicle travels, and decreases again when the vehicle is stopped. This pattern may be similar to a pattern of the predicted vehicle speed and may fluctuate up and down. Additionally, in the case of the conventional control method, a section in which the COP is lower than the COP average may occur.

In the case of a real-time vehicle speed control method, the system duty may be controlled according to the actual vehicle speed detected while the vehicle 100 travels. For example, as shown in FIG. 7, the COP of the air conditioning system is higher in all sections than the COP of the present disclosure that controls the system duty based on the vehicle speed prediction model. Therefore, it may be seen that the real-time vehicle speed control method outperforms the embodiment of the present disclosure. However, in the case of the real-time vehicle speed control method, a system duty that always maintains a high COP may be used regardless of whether the vehicle is stopped or travels. This may mean that 10% system duty is used even when the vehicle is stopped, and thus the air conditioning system may not provide cool-down performance, i.e., a rapid cooling effect.

On the other hand, in the case of a method of controlling the system duty based on the predicted vehicle speed according to the embodiment of the present disclosure, the COP may have a value greater than the COP average while the vehicle travels. That is, in a case in which the vehicle is stopped in the standby state in the garage, when the system duty is controlled to 100%, the COP is the lowest but below the COP average, and thus the system duty may be lowered to a degree that allows cooling down while ensuring that the COP does not fall below the COP average. Accordingly, the present disclosure may prevent the lowest system duty (e.g., 10% system duty) from being calculated when the vehicle is stopped, and thus the cooling starts at a state where the COP is higher than the COP average, and at the same time, cool-down performance is provided.

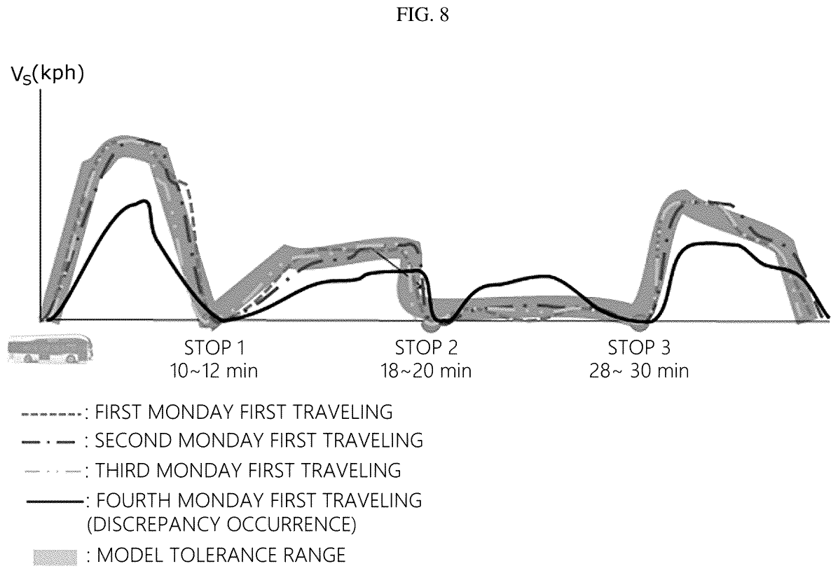

FIG. 8 is a schematic example diagram for describing an operation of generating and updating the vehicle speed prediction model by the first processor 240.

Firstly, the first processor 240 may perform repeated learning to secure the accuracy of the vehicle speed prediction model. The first processor 240 may generate the vehicle speed prediction model by machine learning vehicle speed data (or traveling data) and then may repeatedly learn the vehicle speed data to ensure an accuracy of about 90% or higher. Here, 90% is an example and may be changed to be greater or less than this. Additionally, the first processor 240 may regard the vehicle speed data used for the vehicle speed prediction as dummy data when the predicted vehicle speed deviates from a tolerance range of the vehicle speed prediction (for example, adjustable to about +10%).

Additionally, the first processor 240 may provide a countermeasure when a discrepancy occurs between the predicted vehicle speed and the actual vehicle speed.

For example, when the difference between the actual vehicle speed and the predicted vehicle speed is large enough to affect system duty control, the edge device 200 may command the ACP 300 to perform real-time control, and the ACP 300 may control the system duty in real time based on the actual vehicle speed detected in real time. Affecting the control of the system duty may include, for example, causing the COP to be lower than the COP average or causing energy consumption to increase excessively. The first processor 240 may collect traveling data while the ACP 300 performs real-time control and stores the traveling data in the first DB 220.

In addition, the first processor 240 may monitor whether a discrepancy between the predicted vehicle speed and the actual vehicle speed occurs for a set period when the discrepancy is resolved. When the number of times the discrepancy occurs continuously is less than N (N is an integer greater than or equal to 2), the first processor 240 may determine that the discrepancy is resolved and may use the vehicle speed prediction model as is. On the other hand, when the discrepancy occurs continuously N or more times, the first processor 240 may modify the vehicle speed prediction model with the traveling data collected during the set period. The set period may be a period during which the discrepancy occurs continuously among the periods set to monitor whether a discrepancy occurs in vehicle speed.

For example, the first processor 240 may monitor the vehicle 100 that travels first on Monday for three weeks as shown in FIG. 8 to determine whether the discrepancy occurs repeatedly. When the discrepancy continuously occurs for three weeks, the first processor 240 modifies the vehicle speed prediction model using the traveling data collected during the period in which the discrepancy occurs (at least three weeks in the case of FIG. 8).

On the other hand, when the discrepancy does not continuously occur for three weeks and occurs in the first week and does not occur in the second week and the third week, the first processor 240 may regard the traveling data collected in the first week as dummy data and may predict the vehicle speed using the current vehicle speed prediction model. The three weeks, first on Monday, etc., described above are conditions set to determine the discrepancy in the vehicle speed prediction model and may be changed, and it is not limited thereto.

Meanwhile, according to another embodiment of the present disclosure described above, it is possible to observe a change in interior air conditioning control by arbitrarily generating a situation in which a high discrepancy rate occurs during real-time traveling for a long period of time according to a vehicle speed prediction model and a system duty function model. It is possible to leave the vehicle in an idling state, i.e., the stationary state, for generating a high discrepancy rate.

For example, a new vehicle speed prediction model may be generated by repeating the operation of starting the vehicle, operating the air conditioning system, and then learning data at a real-time vehicle speed of 0 km/h, and the air conditioning system is operated under conditions of a high system duty and a low COP in the idling state. A newer vehicle speed prediction model may be generated by repeating such an operation, and the air conditioner may be operated under conditions of a high duty and a low COP in the idling state. As the vehicle starts traveling, a newer vehicle speed prediction model may be generated by repeating the operation, and the air conditioner may be operated under conditions of a low duty and a high COP in the idling state. In this way, by observing the change in system duty while operating the air conditioning system in the idling state, the vehicle speed prediction model may be managed.

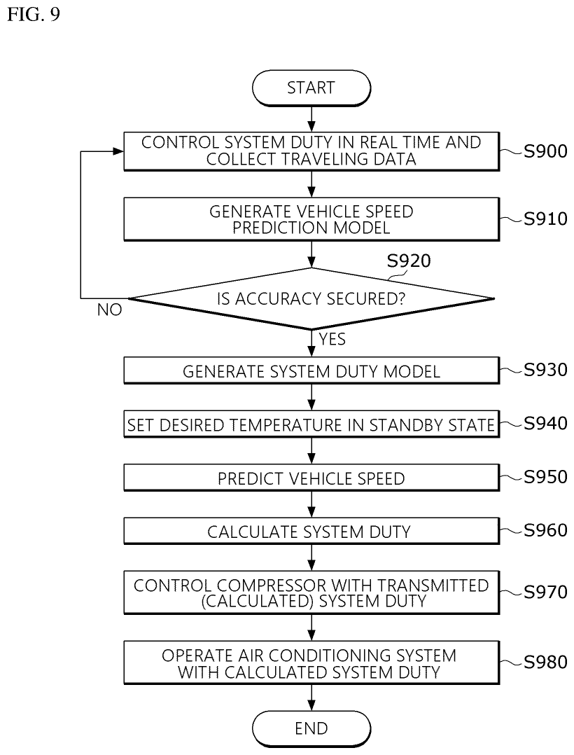

FIG. 9 is a schematic flowchart showing a control method of the air conditioning control system 180 according to the embodiment of the present disclosure.

The control method of the air conditioning control system 180 shown in FIG. 9 may be performed by the edge device 200 and the ACP 300.

Referring to FIG. 9, the edge device 200 may collect traveling data while the vehicle 100 travels along a route and may store the traveling data in the first DB 220 (S900). In step S900, the ACP 300 may control the system duty of the air conditioning system 110 in real time based on the actual speed (i.e., real-time speed) of the vehicle 100.

The edge device 200 may generate a vehicle speed prediction model by performing AI machine learning on the collected traveling data (S910). The vehicle speed prediction model may predict the near-future vehicle speed of the vehicle 100.

When the accuracy of the generated vehicle speed prediction model is secured (S920—Y), the edge device 200 may generate a system duty model based on the vehicle speed predicted by the vehicle speed prediction model (S930). The system duty model may calculate the system duty for controlling the compressor of the air conditioning system 110 based on the predicted vehicle speed. The generated vehicle speed prediction model and system duty model may be stored in the edge device 200.

On the other hand, when the accuracy of the generated vehicle speed prediction model is not secured (S920—N), the edge device 200 may perform steps S900 and S910 again. That is, the edge device 200 may collect the traveling data again while controlling the system duty in real time according to the actual speed of the vehicle 100 and regenerate (or modify) the vehicle speed prediction model using the collected driving data.

When the vehicle 100 is in the standby state and the desired interior temperature of the vehicle 100 is set by the driver (S940), the edge device 200 may predict the near-future vehicle speed (S950).

The edge device 200 may calculate the system duty using the predicted vehicle speed, the current interior temperature, the set temperature, and Equation 1 (S960). Step S960 may calculate the system duty using the system duty model such that the COP becomes higher than the COP average according to the predicted vehicle speed.

The edge device 200 may transmit the calculated system duty to the ACP 300, and the ACP 300 may control the compressor of the air conditioning system 110 with the transmitted (or calculated) system duty (S970). Accordingly, the air conditioning system 110 may be operated with the system duty calculated based on the predicted vehicle speed and the temperature difference (S980), thereby saving energy while maintaining a high COP.

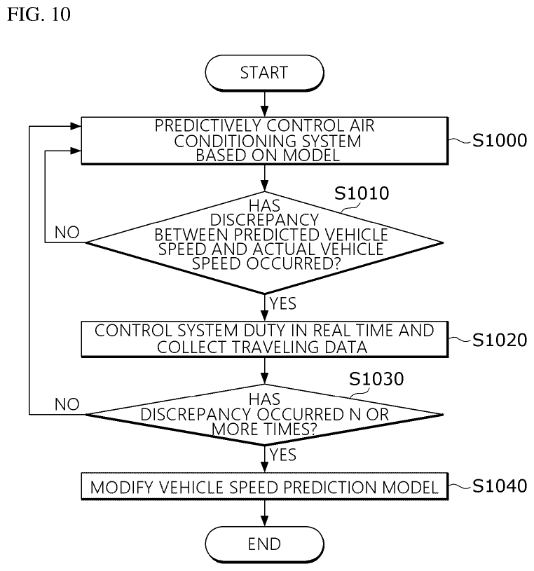

FIG. 10 is a schematic flowchart showing a method of generating and updating the vehicle speed prediction model of the edge device 200 according to the embodiment of the present disclosure.

Referring to FIG. 10, the edge device 200 may calculate the system duty based on the vehicle speed prediction model generated in step S910 and predictively control the compressor of the air conditioning system with the calculated system duty (S1000). Step S1000 may include steps S950 to S980 of FIG. 9.

The edge device 200 may determine whether a discrepancy occurs between the predicted vehicle speed and the actual vehicle speed while controlling the compressor with the system duty (S1010). To accomplish this, the edge device 200 may collect the actual vehicle speed from the vehicle speed sensor 160 while performing step S1000.

When the edge device 200 determines that a discrepancy occurs (S1010-Y), the edge device 200 may notify the ACP 300 to directly control the rotation speed of the compressor, the ACP 300 may control the system duty in real time based on the actual vehicle speed, and the edge device 200 may collect the traveling data in real time (S1020). On the other hand, when the discrepancy does not occur, then the edge device 200 may perform step S1000 (S1010—N).

Then, the edge device 200 may determine whether the discrepancy occurs N or more times (S1030). When the discrepancy occurs (or continuously occurs) N or more times (S1030-Y), the edge device 200 may modify the vehicle speed prediction model using the traveling data collected in step S1020 (S1040).

On the other hand, when the discrepancy occurs (or continuously occurs) less than N times (N is an integer greater than or equal to 2), the edge device 200 may perform step S1000 (S1030—N).

According to the present disclosure, by predicting a near-future vehicle speed when a bus travels using a vehicle speed prediction model and controlling the system duty of an air conditioner compressor based on the predicted vehicle speed and an air conditioner temperature, the efficiency of an air conditioner can be increased while also securing rapid effectiveness.

In particular, the present disclosure may predict a system duty by executing model-based predictive control (MPC) that predicts a vehicle speed while a vehicle travels on a route and controls air conditioning to operate at the predicted system duty, thereby reducing air conditioning operation energy that may be wasted during vehicle traveling.

In addition, according to the present disclosure, by updating a vehicle speed prediction model based on a vehicle speed measured in real time and a predicted vehicle speed when a vehicle such as a bus travels, an appropriate vehicle speed prediction model can be generated according to traffic conditions (e.g., a route change, a change in road traffic volume, etc.), and the system duty of an air conditioner can be efficiently controlled.

The effects of the present disclosure are not limited to those described above, and other effects that are not described will be clearly understood by those skilled in the art from the description above.

In the above, although all components constituting the embodiments of the present disclosure have been described as being combined into one or being combined into one and operated, the present disclosure is not necessarily limited to these embodiments. That is, within the scope of the purpose of the present disclosure, all of the components may be selectively combined into one or more and operated. Additionally, while each of these components may be implemented as a single independent piece of hardware, some or all of these components may be selectively combined and implemented as a computer program having program modules that perform some or all of the functions of the combined hardware in one or more pieces. The code and code segments constituting the computer program may be easily inferred by those skilled in the art of the present disclosure. These computer programs may be stored in computer readable media and read and executed by a computer, thereby implementing embodiments of the present disclosure.

Meanwhile, although the present disclosure has been described and illustrated with reference to exemplary embodiments for illustrating the technical idea thereof, it will be readily understood by those skilled in the art that the present disclosure is not limited to the configurations and operations as illustrated and described above and that numerous changes and modifications can be made to the present disclosure without departing from the scope of the technical idea thereof. Accordingly, all such appropriate changes and modifications and equivalents should also be regarded to fall within the scope of the present disclosure. Therefore, the true technical protection scope of the present disclosure should be determined by the technical idea of the attached claims.

What is claimed is:

1. An air conditioning control system comprising:
an edge device configured to:
predict a vehicle speed of a vehicle traveling from a starting location to a destination based on a vehicle speed prediction model, and
calculate a system duty of an air conditioner compressor based on the predicted vehicle speed; and
an air control panel configured to control the system duty of the air conditioner compressor based on the system duty calculated by the edge device.

2. The air conditioning control system of claim 1, wherein the edge device is configured to:
generate the vehicle speed prediction model that predicts the vehicle speed of the vehicle based on past traveling data collected from the vehicle, and
generate a system duty model that calculates the system duty based on the vehicle speed predicted by the vehicle speed prediction model.

3. The air conditioning control system of claim 2, wherein the edge device is configured to generate the system duty model further based on a difference between a set interior temperature and a current interior temperature of the vehicle.

4. The air conditioning control system of claim 2, wherein the edge device is configured to calculate the system duty using the system duty model such that a coefficient of performance becomes higher than a reference value based on the predicted vehicle speed.

5. The air conditioning control system of claim 1, wherein the air conditioning control system is a roof-type in which the system duty model is as follows:
$$D = {k}_{1} \cdot Δ t + {k}_{2} \cdot ( 1 - \frac{v ( t )}{{v}_{max}} ) ,$$
where, D is a system duty of the air conditioner compressor, Δt is a difference between tᵣₒₒₘ and tₛₑₜ, tᵣₒₒₘ is a current interior temperature of the vehicle, tₛₑₜ is a set temperature, v(t) is a predicted vehicle speed, vₘₐₓ is a maximum speed of the vehicle, and k₁ and k₂ are system duty adjustment coefficients.

6. The air conditioning control system of claim 1, wherein the air control panel is configured to control the system duty in real time based on a measured actual vehicle speed of the vehicle when a discrepancy occurs between the vehicle speed predicted by the vehicle speed prediction model and the actual vehicle speed.

7. The air conditioning control system of claim 6, wherein the edge device is configured to modify the vehicle speed prediction model based on traveling data collected during a set period when the discrepancy occurs N or more times (N is an integer greater than or equal to 2) during the set period.

8. A control method of an air conditioning control system, the control method comprising:
predicting, by an edge device, a vehicle speed of a vehicle traveling from a starting location to a destination based on a vehicle speed prediction model and calculating a system duty of an air conditioner compressor based on the predicted vehicle speed; and
controlling, by an air control panel, the system duty of the air conditioner compressor based on the system duty calculated by the edge device.

9. The control method of claim 8, further comprising:
generating, by the edge device, the vehicle speed prediction model that predicts the vehicle speed of the vehicle based on past traveling data collected from the vehicle; and
generating, by the edge device, a system duty model that calculates the system duty based on the vehicle speed predicted by the vehicle speed prediction model.

10. The control method of claim 9, wherein generating the system duty model includes calculating the system duty based on a difference between a set interior temperature and a current interior temperature of the vehicle.

11. The control method of claim 9, wherein calculating the system duty includes calculating the system duty using the system duty model such that a coefficient of performance becomes higher than a reference value based on the predicted vehicle speed.

12. The control method of claim 8, wherein the system duty model is as follows:
$$D = {k}_{1} \cdot Δ t + {k}_{2} \cdot ( 1 - \frac{v ( t )}{{v}_{max}} ) ,$$
where, D is a system duty of the air conditioner compressor, Δt is a difference between tᵣₒₒₘ and tₛₑₜ, tᵣₒₒₘ is a current interior temperature of the vehicle, tₛₑₜ is a set temperature, v(t) is a predicted vehicle speed, vₘₐₓ is a maximum speed of the vehicle, and k₁ and k₂ are duty adjustment coefficients.

13. The control method of claim 8, further comprising:
controlling, by the air control panel, the system duty in real time based on a measured actual vehicle speed of the vehicle based on a determination that a discrepancy occurs between the vehicle speed predicted by the vehicle speed prediction model and the actual vehicle speed.

14. The control method of claim 13, further comprising:
modifying, by the edge device, the vehicle speed prediction model based on traveling data collected during a set period based on a determination that the discrepancy occurs N or more times (N is an integer greater than or equal to 2) during the set period.

15. A vehicle equipped with a roof-type air conditioning system, the vehicle comprising:
an edge device configured to predict a vehicle speed of the vehicle traveling from a starting location to a destination based on a vehicle speed prediction model and calculate a system duty of an air conditioner compressor based on the predicted vehicle speed; and
an air control panel configured to control the system duty of the air conditioner compressor based on the system duty calculated by the edge device.

16. The vehicle of claim 15, wherein the edge device is configured to:
generate the vehicle speed prediction model that predicts the vehicle speed of the vehicle based on past traveling data collected from the vehicle; and
generate a system duty model that calculates the system duty based on the vehicle speed predicted by the vehicle speed prediction model.

17. The vehicle of claim 16, wherein the edge device is configured to generate the system duty model such that the system duty is calculated based on a difference between a set interior temperature and a current interior temperature of the vehicle.

18. The vehicle of claim 16, wherein the edge device is configured to adjust the system duty using the system duty model by predicting a section in which a coefficient of performance becomes higher than a reference value based on the predicted vehicle speed.

19. The vehicle of claim 15, wherein the system duty model is as follows:
$$D = {k}_{1} \cdot Δ t + {k}_{2} \cdot ( 1 - \frac{v ( t )}{{v}_{max}} ) ,$$
where, D is a system duty of the air conditioner compressor, Δt is a difference between tᵣₒₒₘ and tₛₑₜ, tᵣₒₒₘ is a current interior temperature of the vehicle, tₛₑₜ is a set temperature, v(t) is a predicted vehicle speed, vₘₐₓ is a maximum speed of the vehicle, and k₁ and k₂ are system duty adjustment coefficients.

20. The vehicle of claim 15, wherein the air control panel is configured to control the system duty in real time based on a measured actual vehicle speed of the vehicle when a discrepancy occurs between the vehicle speed predicted by the vehicle speed prediction model and the actual vehicle speed.

21. The vehicle of claim 20, wherein the edge device is configured to modify the vehicle speed prediction model based on traveling data collected during a set period when the discrepancy occurs N or more times (Nis an integer greater than or equal to 2) during the set period.
